(19) United States
(12) Patent Application Publication
(10) Pub. No.: US 2016/0238090 A1
(43) Pub. Date: Aug. 18, 2016

(54) WEDGE CLUTCH WITH CENTRIFUGAL RETENTION

(71) Applicant: Schaeffler Technologies AG & Co. KG, Herzogenaurach (DE)

(72) Inventors: George Spencer, Halifax, VA (US); Brian Lee, York, SC (US)

(21) Appl. No.: 14/622,215

(22) Filed: Feb. 13, 2015

(51) Int. Cl. F16D 41/061; F16D 27/112; F16D 15/00

(52) U.S. Cl. CPC F16D 41/061; F16D 15/00; F16D 27/112

(57) ABSTRACT

A wedge clutch, including: an inner race including first and second sides facing in first and second opposite axial directions, respectively and a radially outermost surface sloping radially inward from the second side to the first side; an outer race located radially outward of the inner race; a wedge plate radially disposed between the inner and outer races and including third and fourth sides facing in the first and second axial directions, respectively, a radially innermost surface sloping radially inward from the fourth side to the third side, and a first plurality of retention features; and an axially displaceable retention ring including a second plurality of retention features. In a free-wheel mode the inner and outer races are rotatable with respect to each other and the second plurality of retention features is engaged with the first plurality of retention features to block radially outward expansion of the wedge plate.

### TECHNICAL FIELD

The present disclosure relates generally to a wedge clutch with centrifugal retention, in particular, a wedge clutch with a retention ring including retention features arranged to engage a wedge plate during free-wheel mode for the clutch to prevent the wedge plate from displacing radially outward and frictionally engaging an outer race for the clutch.

### BACKGROUND

Known wedge clutches include inner and outer races and a wedge plates radially disposed between the inner and outer races. Typically, to initiate a locked mode, in which the inner and outer races and wedge plate are non-rotatably connected, the inner race displaces relative the wedge plate to displace the wedge plate radially outward to frictionally engage the outer race. Ideally, during free-wheel mode, when the inner and outer races are rotatable with respect to each other, the wedge plate rotates with the inner race and is free of frictional engagement with the outer race or the extent of frictional engagement between the wedge plate and outer race is insufficient to initiate the locked mode. However, with sufficiently high rotational speeds for the inner race, centrifugal force can displace the wedge plate radially outward, creating sufficient frictional force for an undesired and unplanned switch from the free-wheel mode to the locked mode. Such a switch can cause malfunction of a torque transfer device including the clutch, can damage the clutch and/or the torque transfer device, and may create a safety hazard for a vehicle using the clutch in its drive train.

### SUMMARY

The present disclosure broadly comprises a wedge clutch, including: an inner race including first and second sides facing in first and second opposite axial directions, respectively and a radially outermost surface sloping radially inward from the second side to the first side; an outer race located radially outward of the inner race; a wedge plate radially disposed between the inner and outer races and including third and fourth sides facing in the first and second axial directions, respectively, a radially innermost surface sloping radially inward from the fourth side to the third side, and a first plurality of retention features; and an axially displaceable retention ring including a second plurality of retention features. In a locked mode, the inner race, the wedge plate and the outer race are non-rotatably connected. In a free-wheel mode the inner and outer races are rotatable with respect to each other and the second plurality of retention features is engaged with the first plurality of retention features to block radially outward expansion of the wedge plate.

The present disclosure broadly comprises a wedge clutch, including: an inner race including first and second sides facing in first and second opposite axial directions, respectively and a radially outermost surface sloping radially inward from the second side to the first side; an outer race located radially outward of the inner race; a wedge plate radially disposed between the inner and outer races and including third and fourth sides facing in the first and second axial directions, respectively, a radially innermost surface sloping radially inward from the fourth side to the third side, and a first plurality of retention features; a retention ring including a second plurality of retention features; and an actuation assembly arranged to displace the inner race in the first axial direction to implement a locked mode in which the inner race, the wedge plate and the outer race are non-rotatably connected and displace the inner race in the second axial direction to implement a free-wheel mode in which the inner and outer races are rotatable with respect to each other. In the free-wheel mode, the second plurality of retention features are engaged with the first plurality of retention features to block radially outward expansion of the wedge plate.

The present disclosure broadly comprises a wedge clutch, including: an inner race including first and second sides facing in first and second opposite axial directions, respectively, and a radially outermost surface sloping radially inward from the second side to the first side; an outer race located radially outward of the inner race; a wedge plate radially disposed between the inner and outer races and including third and fourth sides facing in the first and second axial directions, respectively, a radially innermost surface sloping radially inward from the fourth side to the third side, and a first plurality of retention features; a retention ring including a second plurality of retention features; a resilient element urging the inner race in the first axial direction to implement a locked mode in which the inner race, the wedge plate and the outer race are non-rotatably connected; and an electromagnet arranged to displace the inner race in the second axial direction to implement a free-wheel mode in which the inner and outer races are rotatable with respect to each other. In the free-wheel mode, the second plurality of retention features are engaged with the first plurality of retention features to block radially outward expansion of the wedge plate.

### BRIEF DESCRIPTION OF THE DRAWINGS

The nature and mode of operation of the present disclosure will now be more fully described in the following detailed description of the present disclosure taken with the accompanying figures, in which:

FIG. 1 is a perspective view of a cylindrical coordinate system demonstrating spatial terminology used in the present application;

FIG. 2 is a cross-section view of a torque transfer unit including a wedge clutch with centrifugal retention;

FIG. 3 is a detail of area 3, 4 in FIG. 2 showing a locked mode for the wedge clutch;

FIG. 4 is a detail of area 3, 4 in FIG. 2 showing a free-wheel mode for the wedge clutch;

FIG. 5 is a perspective view of the inner race shown in FIG. 2;

FIG. 6 is a perspective view of the wedge plate shown in FIG. 2;

FIG. 7 is a perspective view of the retention ring shown in FIG. 2;

FIG. 8 is a perspective view of the inner race, retention ring and wedge plate shown in FIG. 2;

FIG. 9 is a perspective view of a retention ring for a wedge clutch with centrifugal retention;

FIG. 10 is a perspective view of a wedge plate for a wedge clutch with centrifugal retention; and,

FIG. 11 is a perspective view of a retention ring for a wedge clutch with centrifugal retention.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

Unless defined otherwise, all technical and scientific terms used herein have the same meaning as commonly understood to one of ordinary skill in the art to which this present disclosure belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

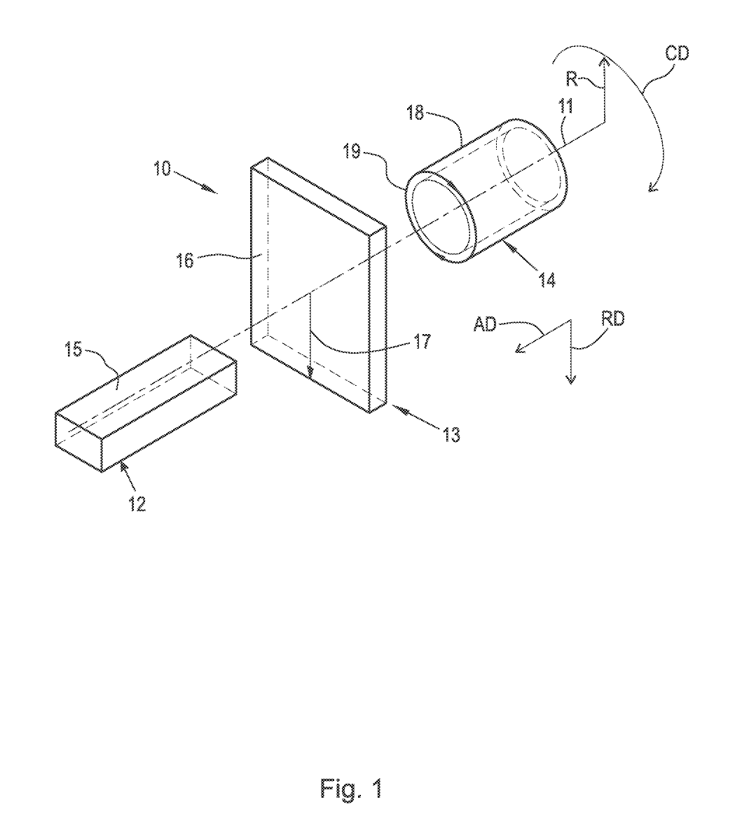

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 is passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

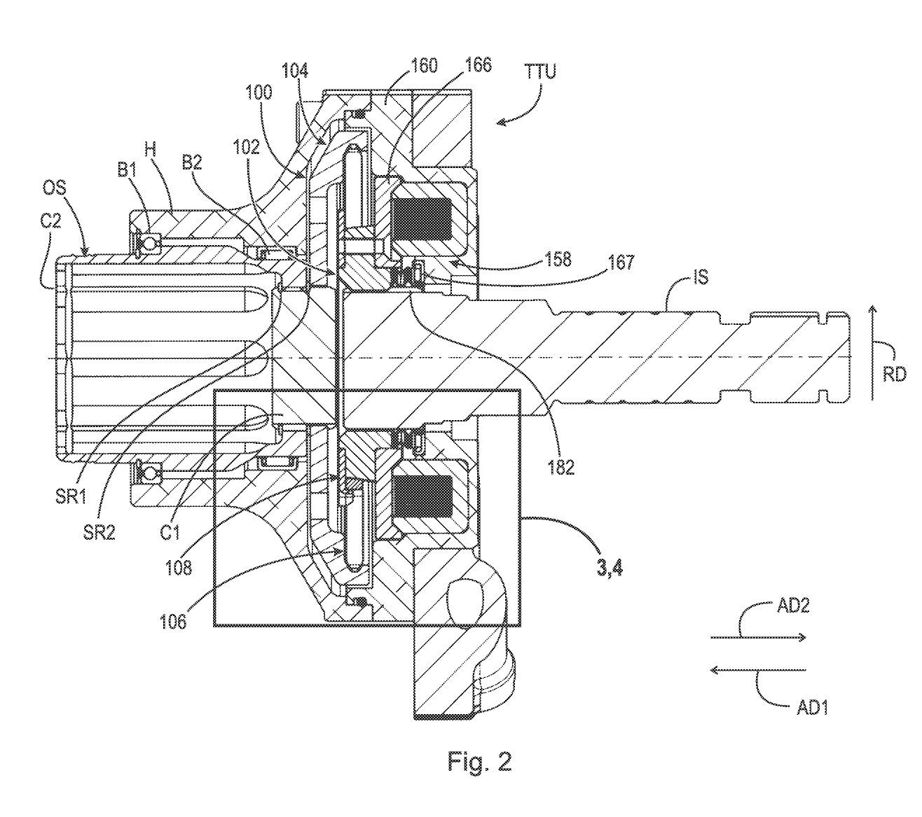

FIG. 2 is a cross-section view of torque transfer unit TTU including wedge clutch 100 with centrifugal retention.

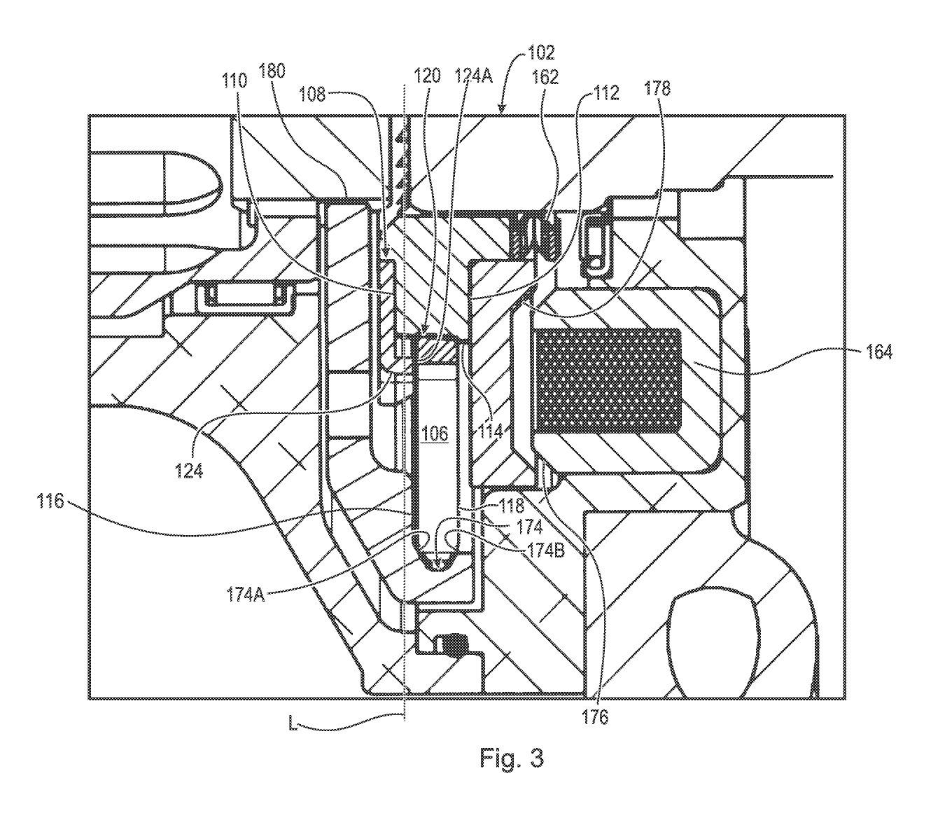

FIG. 3 is a detail of area 3, 4 in FIG. 2 showing a locked mode for wedge clutch 100.

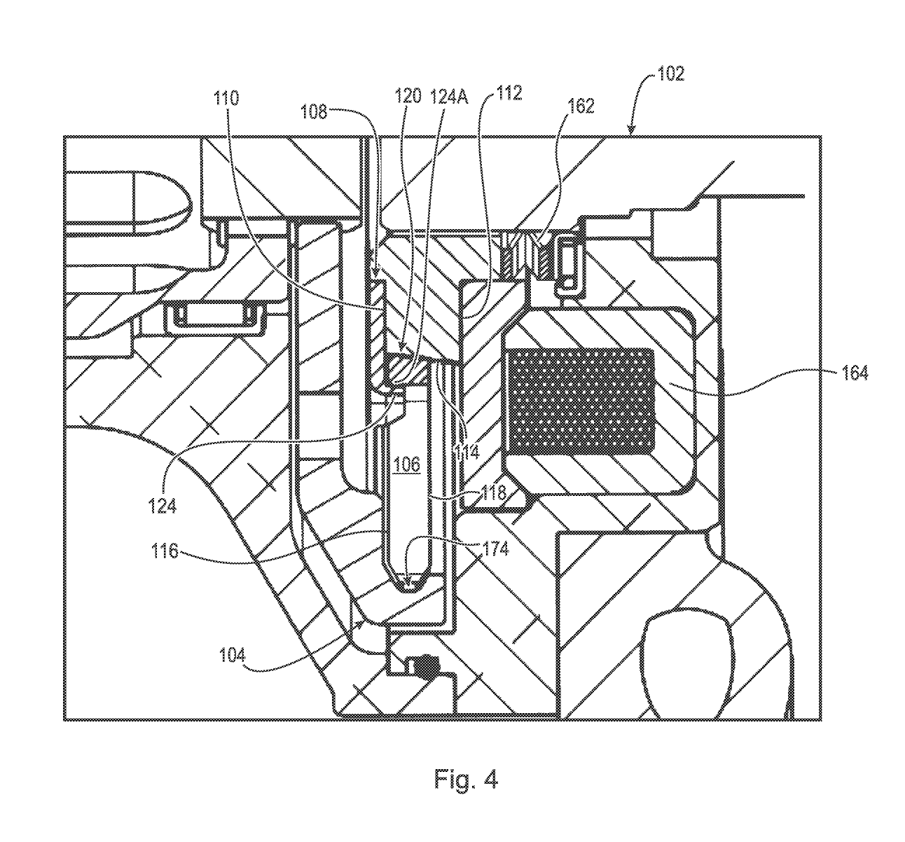

FIG. 4 is a detail of area 3, 4 in FIG. 2 showing a free-wheel mode for wedge clutch 100.

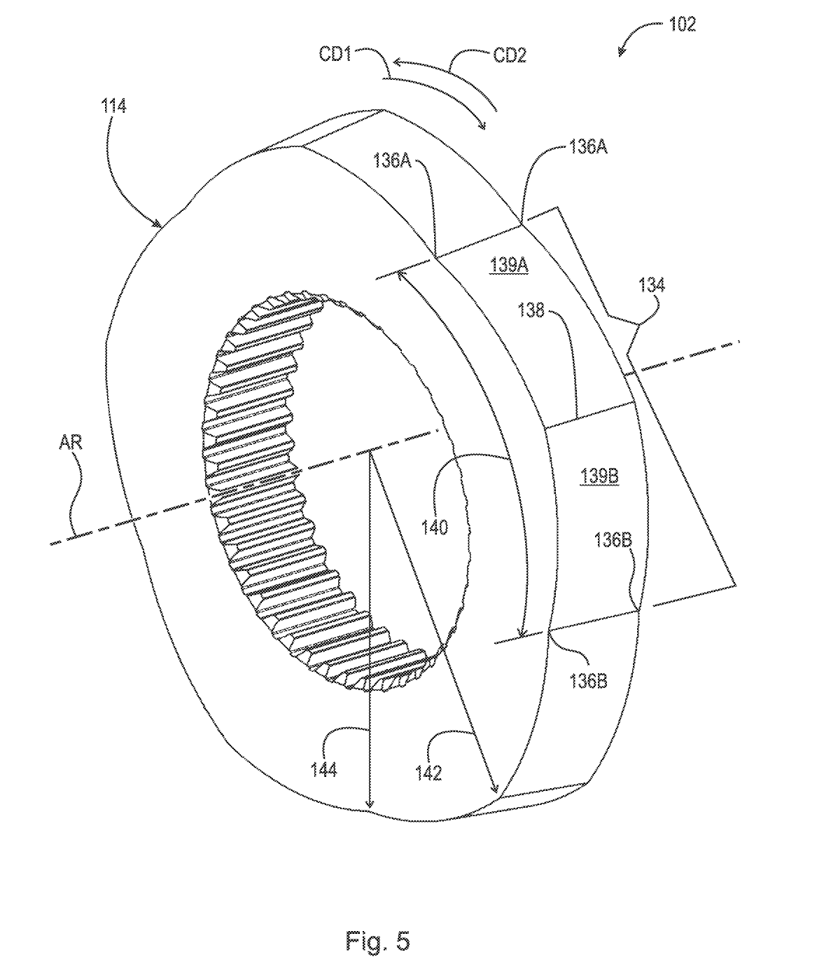

FIG. 5 is a perspective view of inner race 102 shown in FIG. 2.

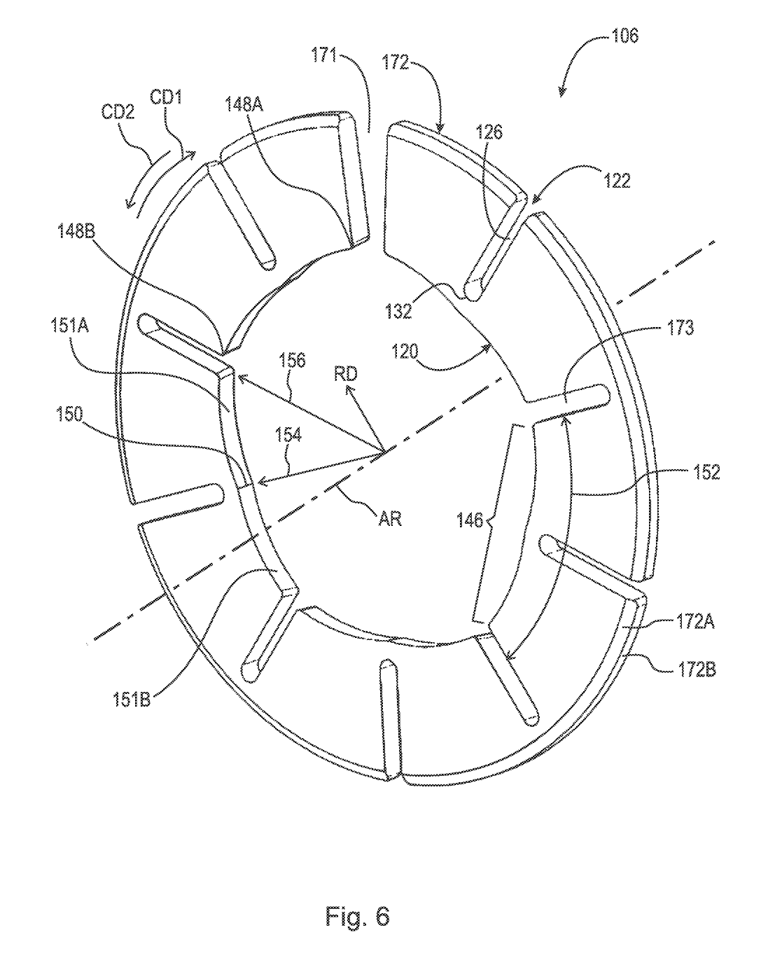

FIG. 6 is a perspective view of the wedge plate shown in FIG. 2. The following should be viewed in light of FIGS. 2 through 6. Clutch 100 includes inner race 102, outer race 104, wedge plate 106 and retention ring 108. Race 102 includes: sides 110 and 112 facing in opposite axial directions AD1 and AD2, respectively, and, radially outermost surface 114 sloping radially inward from side 112 to 110. Race 104 is located radially outward of inner race 102. Wedge plate 106 is radially disposed between races 102 and 104 and includes: sides 116 and 118 facing in directions AD1 and AD2, respectively; radially innermost surface 120 sloping radially inward from side 118 to side 116; and retention features 122. Ring 108 is non-rotatably connected to race 102, is axially displaceable, and includes retention features 124. By “non-rotatably connected” elements (for example two elements), we mean that the two elements are connected so that whenever the first element rotates, the second element rotates and whenever the second element rotates, the first element rotates. Radial and/or axial movement of one or both of the two elements with respect to each other is possible, but not required, when the two elements are non-rotatably connected.

In a locked mode for clutch 100, inner race 102, wedge plate 106 and outer race 104 are non-rotatably connected. In a free-wheel mode for clutch 100, races 102 and 104 are rotatable with respect to each other, and retention features 124 are engaged with retention features 122 to block radially outward expansion of wedge plate 106 in radial direction RD. Inner race 102 is displaceable in axial direction AD1 to initiate the locked mode and is displaceable in axial direction AD2 to initiate the free-wheel mode.

In an example embodiment, in the locked mode, at least portion 124A of retention features are radially outward of retention features 122. In an example embodiment, in the locked mode, retention features 124 are misaligned with wedge plate 106 so that no line L in radial direction RD, orthogonal to axis of rotation AR for wedge plate clutch 100, passing through retention features 124, also passes through wedge plate 106. That is, features 124 are disengaged from features 122 and do not interfere with the displacement of wedge plate 106 in direction RD.

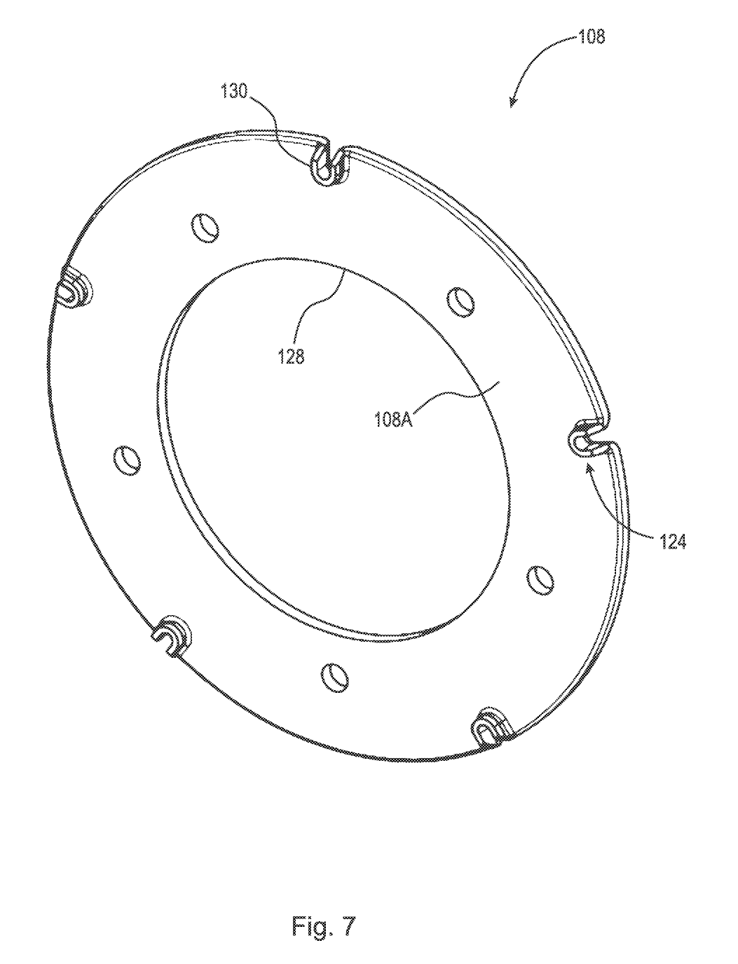

FIG. 7 is a perspective view of retention ring 108 shown in FIG. 2.

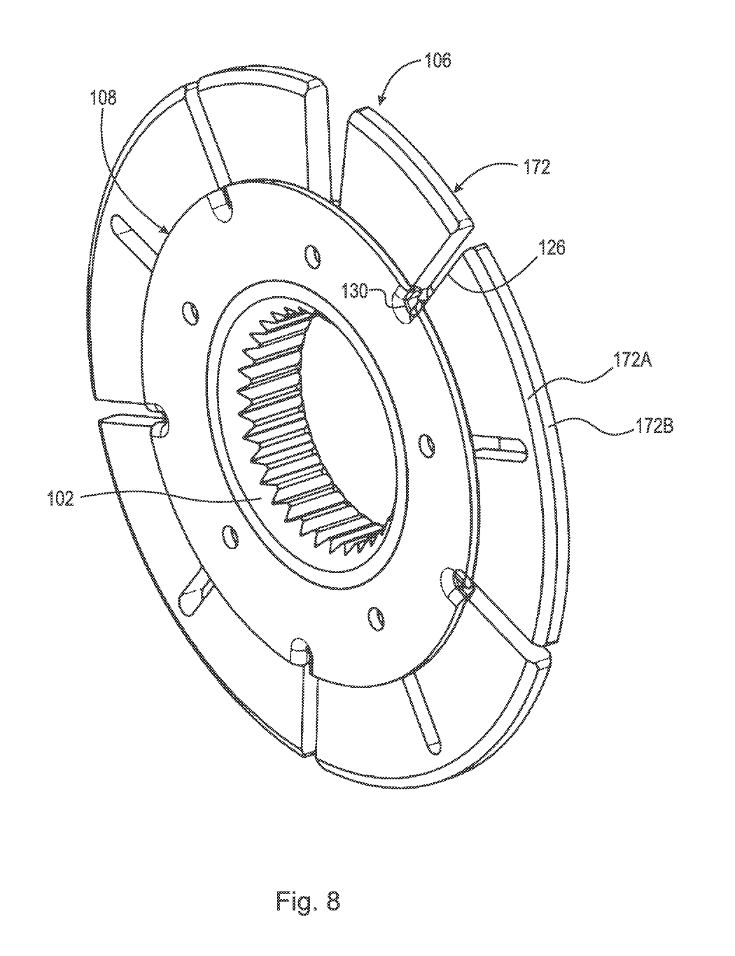

FIG. 8 is a perspective view of the inner race, retention ring and wedge plate shown in FIG. 2. The following should be viewed in light of FIGS. 2 through 8. In an example embodiment: retention features 122 include slots 126 in wedge plate 106; retention ring 108 includes body portion 108A including inner circumference 128 of ring 108; and retention features 124 include protrusions 130 extending in axial direction AD1 or AD2 from body portion 108A. In the example of FIGS. 2 through 8, protrusions 130 extend in direction AD2. Each slot 126 extends radially outward from end 132 formed by wedge plate 106. In the free-wheel mode, protrusions 130 are in contact with ends 132.

In an example embodiment, surface 114 includes segments 134. Each segment 134 includes respective ends 136A and 136B and respective center portion 138 located between ends 136A and 136B in circumferential direction CD. Ramps 139A and 139B are formed between ends 136A and portion 138 and ends 136B and portion 138, respectively. Ends 136A and 136B define circumferential extent 140 of a respective segment 134. Each center portion 138 is at radial distance 142 from axis AR and ends 136A and 136B are at radial distance 144, less than distance 142, from axis AR. Thus, center portions 138 extends radially inward further than ends 136A and 136B.

In an example embodiment, surface 120 includes segments 146. Each segment 146 includes respective ends 148A and 148B and respective center portion 150 located between ends 148A and 148B in circumferential direction CD. Ramps 151A and 151B are formed between ends 148A and portion 150 and ends 148B and portion 150, respectively. Ends 148A and 148B define circumferential extent 152 of a respective segment 146. Each center portion 150 is at radial distance 154 from axis AR and ends 148A and 148B are at radial distance 158, greater than distance 156, from axis AR. Thus, center portions 150 extend radially inward further than ends 148A and 148B.

In an example embodiment, portions 150 are disposed in portions 138 to maintain a circumferential alignment of wedge plate 106 with respect to inner race 102. Thus, since ring 108 is non-rotatably connected to race 102, wedge plate 106 remains circumferentially aligned with ring 108, for example, maintaining circumferential alignment of retention features 122 and 124.

Clutch 100 includes actuation assembly 158. In an example embodiment, assembly 158 is located in housing 160. Actuation assembly 158 is arranged to displace inner race 102 in directions AD1 and AD2. In an example embodiment, assembly 158 includes resilient element 162 and electromagnet 164. Element 162 is engaged with housing 160 and inner race 102 and urges inner race 102 in axial direction AD1. Electromagnet 164 is arranged to be energized so that electromagnet 164 displaces inner race 102 in axial direction AD2 to initiate free-wheel mode. The electromagnet is arranged to be un-energized to enable resilient element 162 to displace inner race 102 in the axial direction AD1 to initiate locked mode. In an example embodiment, clutch 100 includes plate 166 made of magnetic material and fixedly connected to race 102. By “magnetic material” we mean a material that can be attracted by a magnet. Electromagnet 164 is arranged to be energized such that electromagnet 164 attracts plate 166, displacing race 102 in direction AD2. Resilient element 162 can be any suitable resilient element known in the art and electromagnet 164 can be any electromagnet known in the art. Thrust bearing 167 enables relative rotation of resilient element 162 with respect to housing 160.

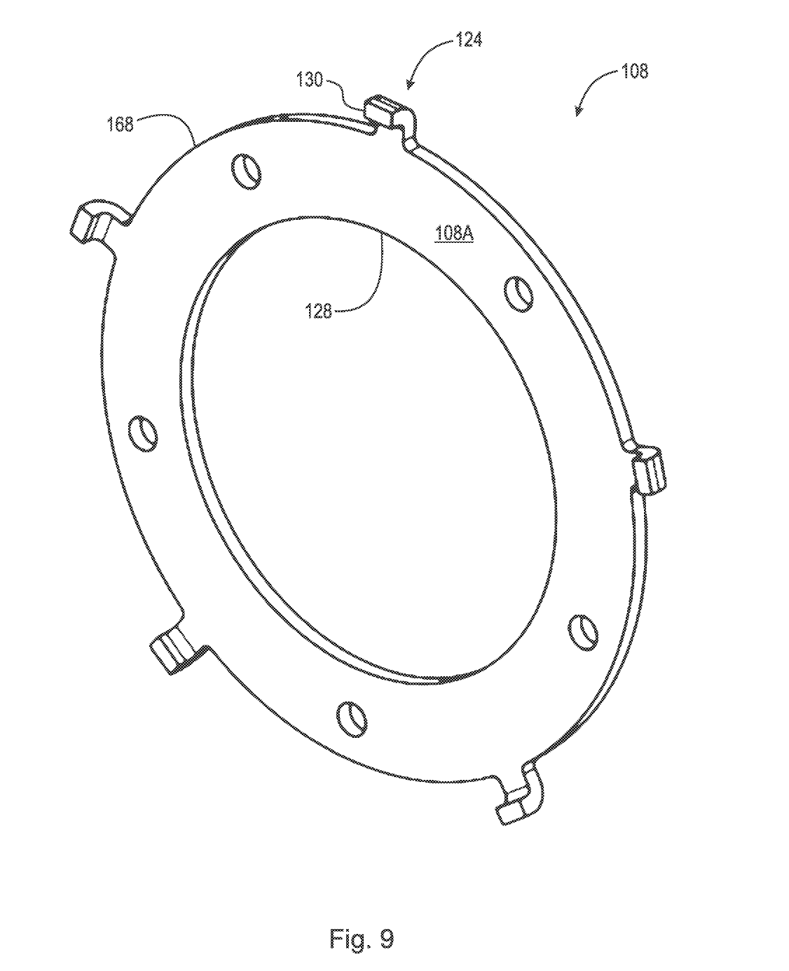

FIG. 9 is a perspective view of a retention ring for wedge clutch 100 with centrifugal retention.

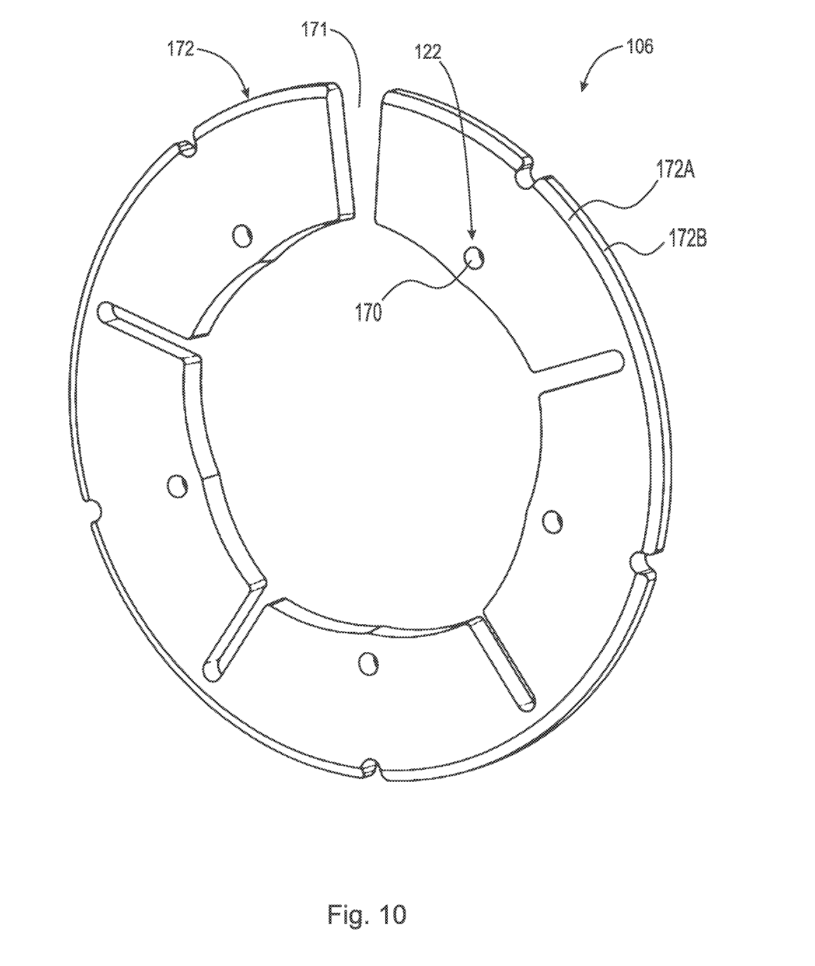

FIG. 10 is a perspective view of a wedge plate for wedge clutch 100 with centrifugal retention.

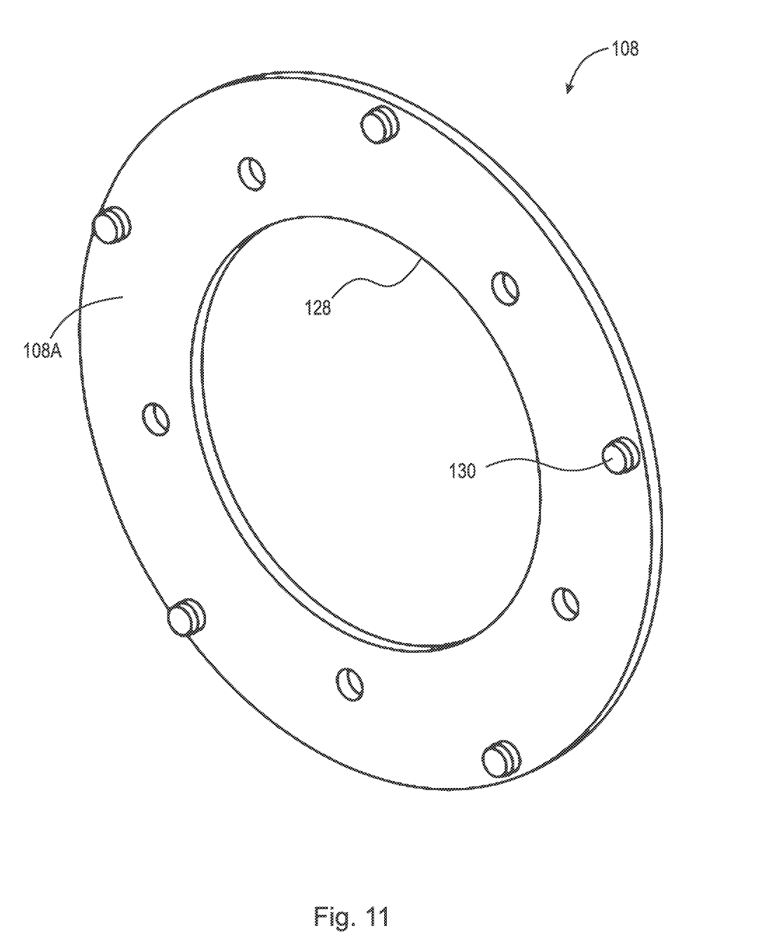

FIG. 11 is a perspective view of a retention ring for wedge clutch 100 with centrifugal retention. The following should be viewed in light of FIGS. 2 through 11. It should be understood that clutch 100 is not limited to the number, shape, size, or configuration of retention elements 122 and 124 shown in FIGS. 2-8. In an example embodiment as shown in FIG. 9, ring 108 includes protrusions 130 extending radially beyond outer circumferential edge 168 for the ring. The discussion for protrusions 130 in FIGS. 2 through 8 is applicable to FIG. 9. In an example embodiment as shown in FIGS. 10 and 11, wedge plate 106 includes features 122 in the form of holes, or indentations, 170 and ring 108 includes features 124 in the form of cylindrical protrusions 130. For the free-wheel mode, race 102 displaces in direction AD2 to insert cylindrical protrusions 130 into holes 170 to prevent further displacement of wedge plate 106 in radially outward direction RD. For the locked mode, race 102 displaces in direction AD1 to remove cylindrical protrusions 130 from holes 170 to enable wedge plate 106 to displace radially outward to frictionally engage race 104.

The following provides further detail regarding clutch 100. In general, wedge plate 106 is biased radially inward so that surface 114 and 120 are in contact, in particular, ramps 139A and 139B are in contact with ramps 151A and 151B, respectively. The biasing of plate 106 and the radial expansion and contraction of plate 106 described below is enabled by gap 171 and slots 126 and 173. In the free-wheel mode, the complimentary slopes of surfaces 114 and 120 and the contact of the ramps result in outer circumferential surface 172 being radially inward of inner circumferential surface 174 by a sufficient amount to eliminate or reduce the frictional contact between surfaces 172 and 174. As a result the lack of frictional contact between surfaces 172 and 174, inner race 102 and wedge plate 106 are rotatable with respect to outer race 104.

To switch from the free-wheel mode to the locked mode, assembly 158 displaces race 102 in direction AD1. The complimentary slopes of surfaces 114 and 120 result in outer circumferential surface 172 being displaced radially outward to frictionally engage inner circumferential surface 174. As a result of the frictional contact between surfaces 172 and 174, race 104 causes wedge plate 106 to rotate with respect to inner race 102. Regardless of the relative rotation of races 102 and 104 with respect to each other, points 138 and 150 move toward each other. For example, for rotation of wedge plate 106 with respect to race 102 in circumferential direction CD1, ramps 151A slide up ramps 139A forcing surface 172 radially outward. For example, for rotation of wedge plate 106 with respect to race 102 in circumferential direction CD2, ramps 151B slide up ramps 139B, forcing surface 172 radially outward. Once the ramps have slid far enough, wedge plate is non-rotatably connected to races 102 and 104 by force in radial direction RD. Continued relative rotation strengthens the force, increasing torque carrying capacity of clutch 100.

To switch from the locked mode to the free-wheel mode, assembly 158 displaces race 102 in direction AD2. The complimentary slopes of surfaces 114 and 120 and the bias of wedge plate 106 result in outer circumferential surface 172 displacing radially inward to break the frictional contact between surfaces 172 and 174 and relieve the force on wedge plate 106 in direction RD. The displacement of race 102 in direction AD2 also engages features 122 and 124, preventing further displacement of wedge plate 106 in direction RD.

In an example embodiment, surface 172 is chamfered and includes segments 172A and 172B. In an example embodiment, surface 174 is a groove in race 104 and includes segments 174A and 174B. In an example embodiment, electromagnet 164 includes chamfered surfaces 176 and plate 166 includes chamfered surfaces 178.

In an example embodiment, TTU includes housing H, input shaft IS and output shaft OS. Bearings B1 and B2 enable rotation of housing H with respect to output shaft OS. Snap rings SR1 and SR2 axially fix component C1 of shaft OS with respect to component C2 of shaft OS. Component C1 is non-rotatably connected to race 104 by splines 180 on race 104. Race 102 is non-rotatably connected to shaft IS by splines 182 on race 102, which enable axial displacement of race 102 with respect to shaft IS.

As noted above, during free-wheel mode for a wedge clutch, centrifugal force can cause a wedge plate for the wedge clutch to displace radially outward, causing an unplanned for switch from the free-wheel mode to the locked mode. Advantageously, wedge plate 106 and retention ring 108, in particular, features 122 and 124 prevent the undesired radial displacement of wedge plate 106 during free wheel mode. Specifically, during free-wheel mode, feature 124 engage features 122 to block further radially outward displacement of wedge plate 106. At the same time, features 122 and 124 enable the required radially outward expansion of wedge plate 106 to initiate the locked mode.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A wedge clutch, comprising:
an inner race including:
first and second sides facing in first and second opposite axial directions, respectively; and,
a radially outermost surface sloping radially inward from the second side to the first side;
an outer race located radially outward of the inner race;
a wedge plate radially disposed between the inner and outer races and including:
third and fourth sides facing in the first and second axial directions, respectively;
a radially innermost surface sloping radially inward from the fourth side to the third side; and,
a first plurality of retention features; and,
an axially displaceable retention ring including a second plurality of retention features, wherein:
in a locked mode, the inner race, the wedge plate and the outer race are non-rotatably connected;
in a free-wheel mode:
the inner and outer races are rotatable with respect to each other; and,
the second plurality of retention features is engaged with the first plurality of retention features to block radially outward expansion of the wedge plate.

2. The wedge clutch of claim 1, wherein the inner race is displaceable:
in the first axial direction to initiate the locked mode; and,
in the second axial direction to initiate the free-wheel mode.

3. The wedge clutch of claim 1, wherein in the locked mode, at least a portion of the second plurality of retention features is radially outward of the first plurality of retention features.

4. The wedge clutch of claim 3, wherein in the locked mode, the second plurality of retention features are misaligned with the wedge plate so that no line, in a radial direction orthogonal to an axis of rotation for the wedge plate clutch, passing through the second plurality of retention features also passes through the wedge plate.

5. The wedge clutch of claim 1, wherein:
the plurality of first retention feature includes a plurality of slots in the wedge plate;
the retention ring includes a body portion including an inner circumference of the retention ring; and,
the plurality of second retention features includes a plurality of protrusions extending in the first or second axial direction from the body portion.

6. The wedge clutch of claim 5, wherein:
each slot extends radially outward from a respective end formed by the wedge plate; and,
in the free-wheel mode, the plurality of protrusions are in contact with the respective ends.

7. The wedge clutch of claim 1, wherein the retention ring is non-rotatably connected to the inner race.

8. The wedge clutch of claim 1, wherein:
the first surface includes a first plurality of segments;
each segment in the first plurality of segments includes:
respective first and second ends defining a first circumferential extent of said each segment in the first plurality of segments; and,
a respective first center portion extending radially inward further than the first and second ends and located between the first and second ends in a circumferential direction;
the second surface includes a second plurality of segments;
each segment in the second plurality of segments includes:
respective third and fourth ends defining a second circumferential extent of said each segment in the second plurality of segments; and,
a respective second center portion extending radially inward further than the third and fourth ends and located between the third and fourth ends in the circumferential direction.

9. The wedge clutch of claim 8, wherein the respective first center portions are disposed in the respective second center portions to maintain a circumferential alignment of the wedge plate with respect to the inner race.

10. The wedge clutch of claim 1, further comprising:
a housing; and,
a resilient element:
engaged with the housing and the inner race; and,
urging the inner race in the first axial direction.

11. The wedge clutch of claim 10, further comprising:
an electromagnet disposed within the housing, wherein:
the electromagnet is arranged to be energized to displace the inner race in the second axial direction to initiate the free-wheel mode; and,
the electromagnet is arranged to be un-energized so that the resilient element displaces the inner race in the first axial direction to initiate the locked mode.

12. The wedge clutch of claim 11, further comprising:
a plate of magnetic material non-rotatably connected to the inner race, wherein, the electromagnetic actuator is arranged to attract the plate.

13. A wedge clutch, comprising:
an inner race including:
first and second sides facing in first and second opposite axial directions, respectively; and,
a radially outermost surface sloping radially inward from the second side to the first side;
an outer race located radially outward of the inner race;
a wedge plate radially disposed between the inner and outer races and including:
third and fourth sides facing in the first and second axial directions, respectively;
a radially innermost surface sloping radially inward from the fourth side to the third side; and,
a first plurality of retention features;
a retention ring including a second plurality of retention features; and,
an actuation assembly arranged to:
displace the inner race in the first axial direction to implement a locked mode in which the inner race, the wedge plate and the outer race are non-rotatably connected; and,
displace the inner race in the second axial direction to implement a free-wheel mode in which the inner and outer races are rotatable with respect to each other, wherein:
in the free-wheel mode, the second plurality of retention features are engaged with the first plurality of retention features to block radially outward expansion of the wedge plate.

14. The wedge clutch of claim 13, wherein:
the plurality of first retention feature includes a plurality of slots in the wedge plate;
the retention ring includes a body portion including an inner circumference of the retention ring; and,
the plurality of second retention features includes a plurality of protrusions extending in the first or second axial direction from the body.

15. The wedge clutch of claim 13, wherein:
the first surface includes a first plurality of segments;
each segment in the first plurality of segments includes:
respective first and second ends defining a first circumferential extent of said each segment in the first plurality of segments; and,
a respective first center portion extending radially inward further than the first and second ends and located between the first and second ends in a circumferential direction;
the second surface includes a second plurality of segments;
each segment in the second plurality of segments includes:
respective third and fourth ends defining a second circumferential extent of said each segment in the second plurality of segments; and,
a respective second center portion extending radially inward further than the third and fourth ends and located between the third and fourth ends in the circumferential direction.

16. The wedge clutch of claim 15, wherein the respective first center portions are disposed in the respective second center portions to maintain a circumferential alignment of the wedge plate with respect to the inner race.

17. The wedge clutch of claim 13, further comprising:
a housing, wherein:
the actuation assembly includes:
a resilient element:
engaged with the housing and the inner race; and,
urging the inner race in the first axial direction; and,
an electromagnet disposed within the housing;
the electromagnet is arranged to be energized to displace the inner race in the second axial direction to initiate the free-wheel mode; and,
the electromagnet is arranged to be un-energized so that the resilient element displaces the inner race in the first axial direction to initiate the locked mode.

18. A wedge clutch, comprising:
an inner race including:
first and second sides facing in first and second opposite axial directions, respectively; and,
a radially outermost surface sloping radially inward from the second side to the first side;
an outer race located radially outward of the inner race;
a wedge plate radially disposed between the inner and outer races and including:
third and fourth sides facing in the first and second axial directions, respectively;
a radially innermost surface sloping radially inward from the fourth side to the third side; and,
a first plurality of retention features;
a retention ring including a second plurality of retention features;
a resilient element urging the inner race in the first axial direction to implement a locked mode in which the inner race, the wedge plate and the outer race are non-rotatably connected; and,
an electromagnet arranged to displace the inner race in the second axial direction to implement a free-wheel mode in which the inner and outer races are rotatable with respect to each other, wherein:
in the free-wheel mode, the second plurality of retention features are engaged with the first plurality of retention features to block radially outward expansion of the wedge plate.

19. The wedge clutch of claim 18, wherein in the locked mode, the second plurality of retention features is disengaged from the first plurality of retention features.

20. The wedge clutch of claim 19, wherein:
the first surface includes a first plurality of segments;
each segment in the first plurality of segments includes:
respective first and second ends defining a first circumferential extent of said each segment in the first plurality of segments; and,
a respective first center portion extending radially inward further than the first and second ends and located between the first and second ends in a circumferential direction;
the second surface includes a second plurality of segments;
each segment in the second plurality of segments includes:
respective third and fourth ends defining a second circumferential extent of said each segment in the second plurality of segments; and,
a respective second center portion extending radially inward further than the third and fourth ends and located between the third and fourth ends in the circumferential direction.
